(19) United States
(12) Patent Application Publication
(10) Pub. No.: US 2006/0201119 A1
(43) Pub. Date: Sep. 14, 2006

(54) Air cleaner

(76) Inventor: Sung-Wook Song, Seoul (KR)

Correspondence Address: COLEMAN SUDOL SAPONE, P.C., 714 COLORADO AVENUE, BRIDGE PORT, CT, 06605-1601, US

(21) Appl. No.: 10/552,753

(22) PCT Filed: Mar. 30, 2004
(86) PCT No.: PCT/KR04/00727

§ 371 Date: Nov. 17, 2005

(30) Foreign Application Priority Data
Mar. 2, 2004 (KR) 10-2004-0013963

(51) Int. Cl. B01D 46/00

(52) U.S. Cl. 55/471

(57) ABSTRACT

The present invention relates to an air cleaner capable of quickly cleaning air in a larger area in an improved air circulation construction in which a body of an air cleaner is formed in a cylindrical shape, and air is sucked through an entire surface of a cylindrical body, and the sucked air is passed through a cylindrical filter and a cleaning unit, and the cleaned air is discharged in an upward direction, and in addition it is possible to prevent inlet air and outlet air from being mixed each other for thereby achieving an effective cleaning operation.

### TECHNICAL FIELD

The present invention relates to an air cleaner, and in particular to an air cleaner that is characterized in that a body of an air cleaner is formed in a cylindrical shape, and air is sucked through an entire surface of a cylindrical body, and the sucked air is passed through a cylindrical filter and a cleaning unit, and the cleaned air is discharged in an upward direction.

### BACKGROUND ART

Generally, a conventional small-size air cleaner is hung on a wall or is installed on a table, and a large-size air cleaner is installed on the floor beside a wall.

Since the conventional air cleaner is designed to suck and discharge air in a forward direction, only the air near the air cleaner is cleaned and the air at a distance longer from the system is not cleaned.

In addition, since an air flow section for filtering, cleaning and discharging air is biased in one side, the cross sectional area of the filter is not wide. Therefore, the filter should be often cleaned, so that the life span of the filter is decreased.

The conventional air cleaner has only an air cleaning function without an air sterilization function and a harmful gas removing function. Therefore, an ideal air cleaning is not operated.

Since the conventional air cleaner does not have a warm-air heating function, heating equipment is additionally needed when an indoor temperature is low. Therefore, in the conventional art, both the heating equipment and the air cleaner should be provided separately. In addition, there is not a remote control function, it is inconvenient to use the same.

### DISCLOSURE OF INVENTION

Accordingly, it is an object of the present invention to provide an air cleaner capable of overcoming the problems encountered in the conventional art.

It is another object of the present invention to provide an air cleaner capable of quickly cleaning air in a larger area in an improved air circulation construction in which a body of an air cleaner is formed in a cylindrical shape, and air is sucked through an entire surface of a cylindrical body, and the sucked air is passed through a cylindrical filter and a cleaning unit, and the cleaned air is discharged in an upward direction, and in addition it is possible to prevent inlet air and outlet air from being mixed each other for thereby achieving an effective cleaning operation.

It is further another object of the present invention to provide an air cleaner capable of providing not only an air filtering function but also a gas removing function and a sterilization function for thereby achieving a good quality air.

It is still further another object of the present invention to provide an air cleaner capable of providing a desired warm-air heating without additionally using a heating apparatus when it is needed to increase an indoor temperature.

It is still further another object of the present invention to provide an air cleaner capable of enhancing a convenience of use in such a manner that an operation is automatically performed by setting a cleaning time, and there is provided a wireless remote control function.

To achieve the above objects, there is provided an air cleaner, comprising a cylindrical body fixed to a bottom circular disc wherein an entire appearance of the same is formed of a grill part; a filter unit including a non-woven fabric filter provided in an inner side of the grill part of the cylindrical body, and a cylindrical filer cartridge having a cylindrical wrinkle filter in an inner side; an air inlet guide installed in the interior of the filter unit and having an air inlet part in a lower side wherein an upper side of the same is wide, and a lower side of the same is narrow like a reverse conical shape; an air supply unit assembly including a support circular disc having an air hole and a protrusion part at a center for covering the upper sides of the cylindrical body, the filter unit and the air inlet guide, a motor fixed to the protrusion part of the support circular disc, a fan fixed to a rotary axis of the motor, and a fan housing having an air discharge hole formed along a rim of an upper side surface, while surrounding the fan; a top housing assembled to an upper side surface of the air supply unit assembly and having a controller with an operation knob in an upper side surface, and a handle wherein a rotation discharge guide part corresponding to the air discharge hole is formed along the rim; and an electronic circuit substrate provided between an upper side of the air supply unit assembly and a lower surface of the top housing.

### BRIEF DESCRIPTION OF DRAWINGS

The preferred embodiments of the present invention will be described with reference to the accompanying drawings.

FIG. 1 is a perspective view illustrating an air cleaner according to the present invention;

FIG. 2 is an entire cross sectional view illustrating an air cleaner according to the present invention;

FIG. 3 is a plane cross sectional view illustrating an air cleaner according to the present invention;

FIG. 4 is a disassembled perspective view illustrating a filter unit according to the present invention;

FIG. 5 is a disassembled cross sectional view illustrating major elements of the present invention;

FIG. 6 is a bottom perspective view illustrating an air inlet guide according to the present invention;

FIG. 7 is a view illustrating the construction of a support circular disc; and

FIG. 8 is a view illustrating the construction of a fan housing of an electric heater according to the present invention.

### BEST MODE FOR CARRYING OUT THE INVENTION

The construction and operation of the present invention will be described with reference to the accompanying drawings.

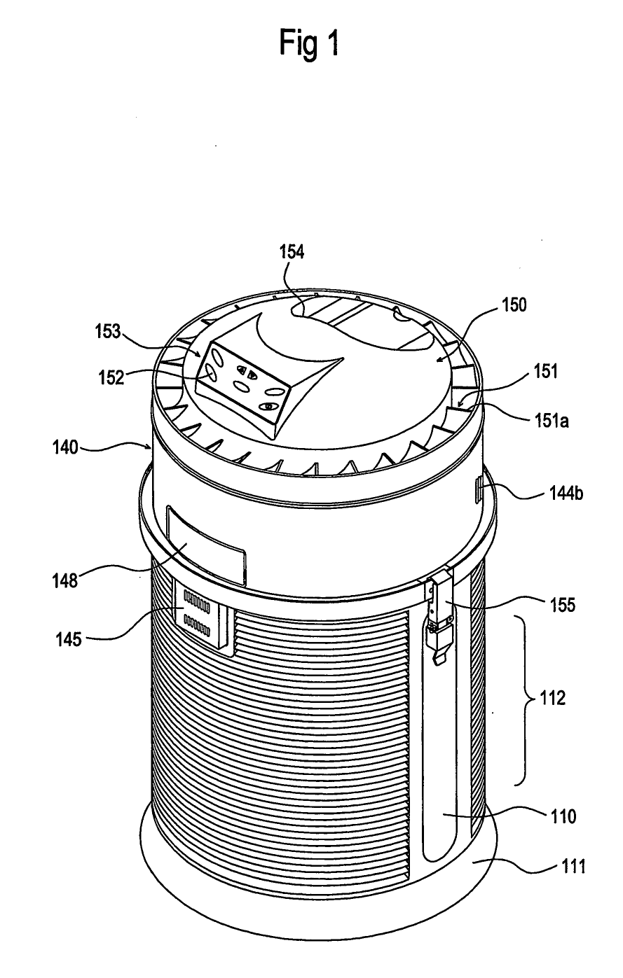

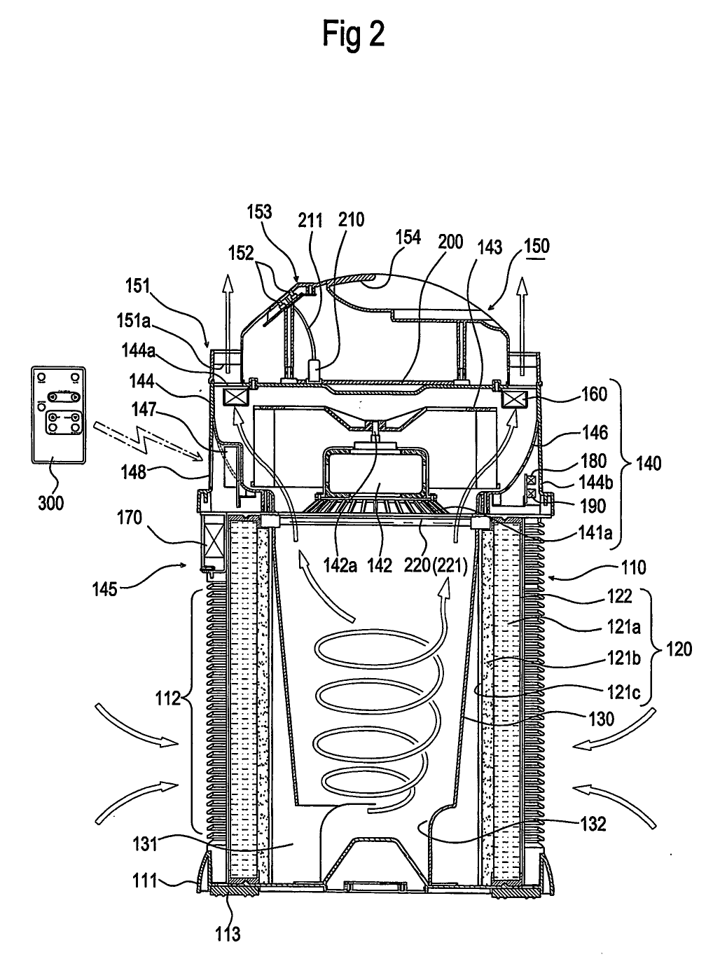

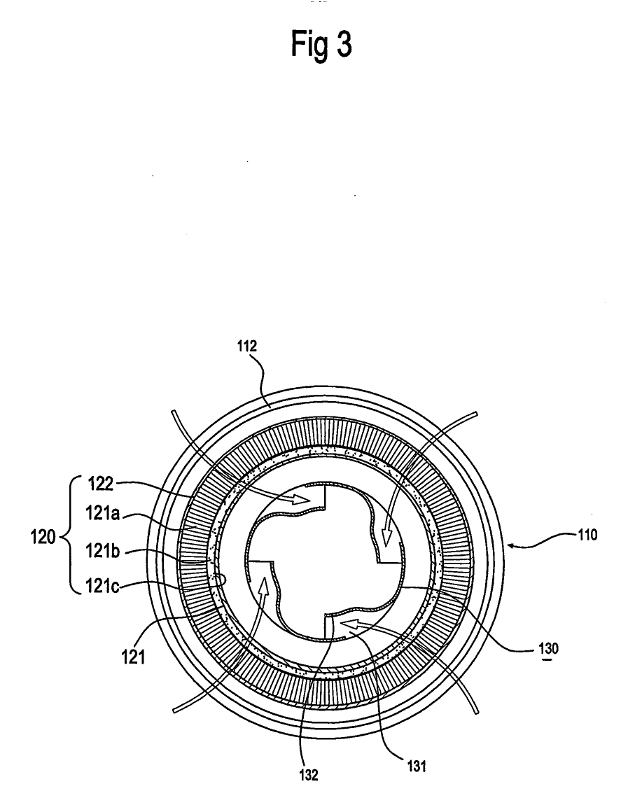

FIG. 1 is a perspective view illustrating an air cleaner according to the present invention, FIG. 2 is an entire cross sectional view, and FIG. 3 is a plane cross sectional view.

The air cleaner according to the present invention includes a cylindrical body 110, a filter unit 120 and an air inlet guide 130 in the interior of the cylindrical body, an air supply unit assembly 140 and a top housing 150 installed in an upper side of the cylindrical body.

The cylindrical body 110 is assembled in such a manner that it is assembled on a bottom circular disc 111 having a rubber support 113 in a lower portion of the same. An entire appearance of the cylindrical body is formed of a grill part 112, so that air is sucked through the entire portions in all directions.

In addition, the filter unit 120 comprises a non-woven fabric filter 122 provided in an inner side of the grill part 112 of the cylindrical body 110, and a filter cartridge 121 installed in the inner side of the non-woven fabric filter 122.

The filter cartridge 121 comprises a wrinkle filter 121a, a carbon filter 121b being adherent to the inner surface of the wrinkle filter 121a, and a nano-silver filter 121c being adherent to the inner surface of the carbon filter 121b.

Here, the non-woven fabric filter 122 is formed of a common filter capable of filtering large-size foreign material.

The wrinkle filter 121a is constructed in such a manner that it is wrinkled along a cylindrical circumferential surface in a zigzag shape, for thereby achieving a good filtering ability based on its larger air contact area.

The carbon filter 121b provided in the interior of the wrinkle filter 121a is made in such a manner that active carbon is carburized for thereby first filtering harmful gas.

The nano-silver filter 121c is made in such a manner that silver particles of a nano unit are filled in the holes of the non-woven fabric for thereby finally filtering harmful fungus and smell contained in air.

Therefore, the air is filtered in the sequence of the non-woven fabric filter 122 of the first state, the wrinkle filter 121a of the second state, the carbon filter 121b of the third stage and the nano-silver filter 121c of the fourth stage.

The air inlet guide 130 is provided in the interior of the center of the filter unit 120 and is formed in a reverse conical shape wherein the upper side is wide, and the lower side is narrow. The air inlet part 131 has a radial wing part 132 for guiding the flow of air to turbulence flow (whirlwind).

In addition, the air supply unit assembly 140 comprise a support circular disc 141 that covers the upper sides of the cylindrical body, the filter unit and the air inlet guide and has an air hole 141a and a protrusion part 141b at the center, a motor 142 fixed to the protrusion part of the support circular disc, a fan 143 installed at a rotary axis 142a of the motor, and a fan housing 144 that surrounds the fan 143 and has an air discharge hole 144a formed along a rim of the upper surface.

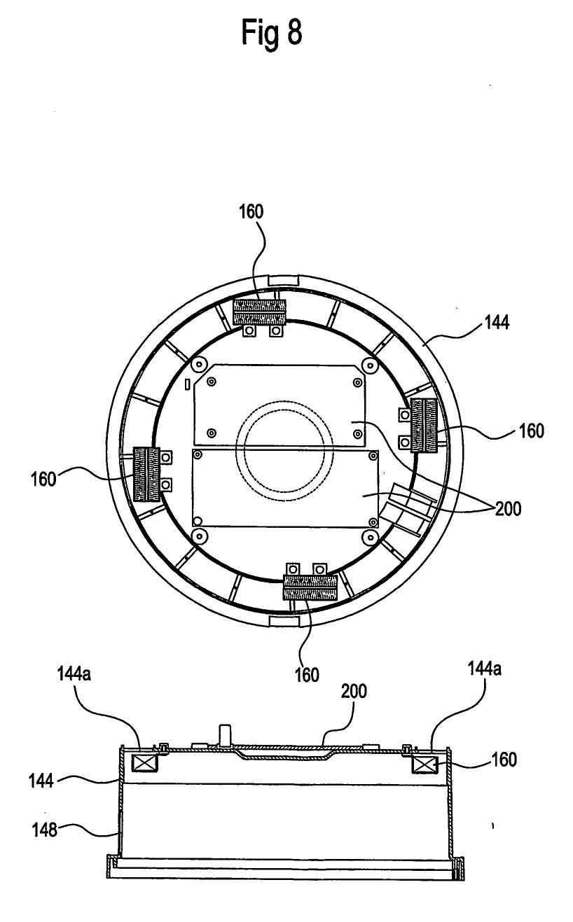

At this time, as shown in FIG. 8, the air supply assembly 140 includes a plurality of electric heaters 160 in an inner side of the air discharge hole 144a.

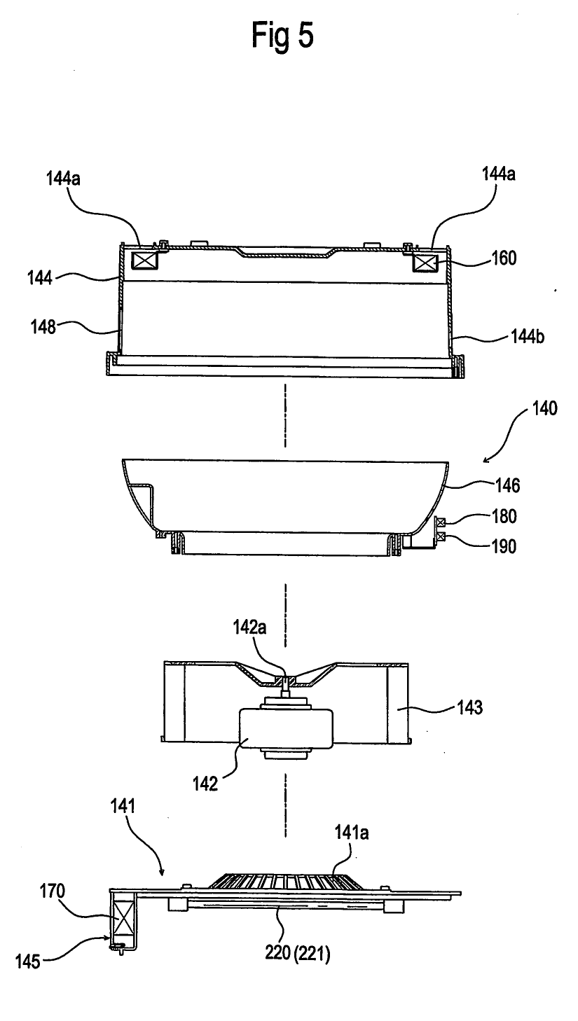

In addition, as shown in FIG. 5, there is provided a sensor cover part 145 extended in the lower direction of one side, and a dust density detection sensor 170 is provided in the interior of the sensor cover part 145 for thereby detecting a dust pollution of the indoor.

As shown in FIG. 2 or 5, a sensor hole 144b is formed in one side of the fan housing 144, and a gas density detection sensor 180 and a temperature is detection sensor 190 are installed in the inner side for thereby detecting pollution level of a harmful gas and temperature of the indoor.

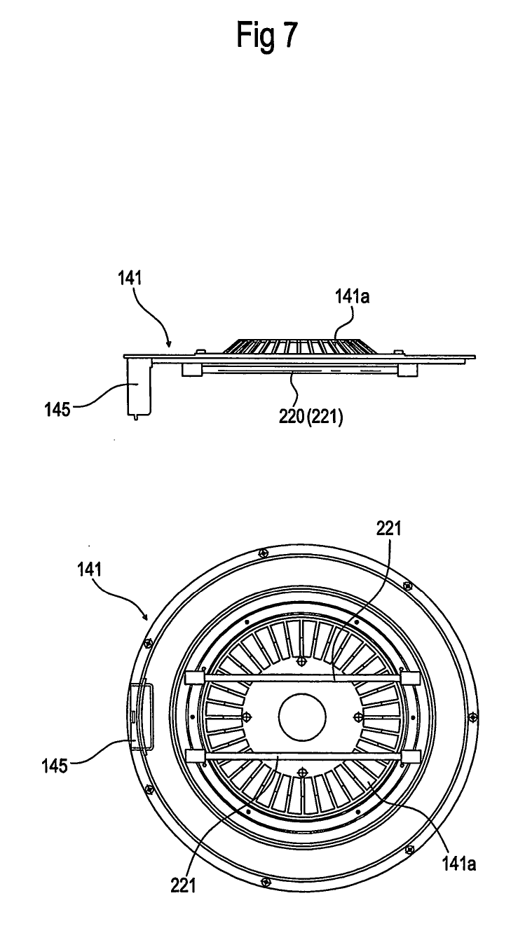

As shown in FIG. 7, an ultraviolet ray sterilizer 220 having a pair of ultraviolet ray lamp 221 is provided on a bottom of the support circular disc 141 for thereby sterilizing the air filtered by the filter unit 120.

In addition, an air guide member 146 is provided in the interior of the air supply unit assembly 140 for guiding the air flowing from the air hole 141a to an air discharge hole 144a in the upper direction, not the bottom direction.

As shown in FIG. 2, a transparent grill 148 is provided in a fan housing 144 in the interior of the front side. A wireless receiving unit 147 is provided in the interior of the same for thereby achieving a remote control using a wireless remote controller 300.

The top housing 150 is assembled to an upper side of the air supply unit assembly, and a rotation discharge guide part 151 corresponding to the air discharge hole 144a is formed along the rim of the fan housing. A controller 153 having an operation knob 152 and a handle 154 are provided in the upper side.

As shown in FIG. 8, an electronic circuit substrate 200 is provided in an upper side of the air supply unit assembly 140 between the lower surfaces of the top housing 150.

Here, the electronic circuit substrate 200 is not described in detail, but it is connected with the power, the operation knobs 152 of the top housing 150, the dust density detection sensor 170 of the sensor cover part 145, the gas density detection sensor 180 of the sensor hole 144b, and the temperature detection sensors 190. In addition, the wireless receiving unit 147 is connected thereto, so that the system is operated by a signal of the wireless remote controller 300.

In addition, an ion generator 210 is provided in one side of the electronic circuit substrate 200, and the ion discharge hose 211 is exposed from one side of the controller 153 to the outside, so that the generated ions are included in the cleaned air.

In FIG. 1, reference numeral 155 represents an engaging ring for attaching and detaching the air supply unit assembly 140 onto/from the cylindrical body.

In the air cleaner according to the present invention, when the power is supplied for cleaning the indoor air, the motor 142 is driven and the fan 143 is rotated.

When the fan 143 is rotated, since the air in the interior of the air inlet guide 130 is upwardly moved by the rotation force, and an external air of the cylindrical body 110 is inputted through the grill part 112 and is cleaned when passing through the non-woven fabric filter 122, the wrinkle filter 121a, the carbon filter 121b, and the nano filter 121c. In a state that the air is cleaned, the air is discharged to the rotation discharge guide part 151 of the top housing 150 through the air supply unit assembly 140.

In the present invention, the air circulation is enhanced in such a manner that since the wings of the grill part 112 of the cylindrical body 110 are inclined at a certain angle, the air near the floor of the indoor are sucked, and the air is discharged to the top housing in the upward direction. Therefore, the air just cleaned and discharged is not sucked again.

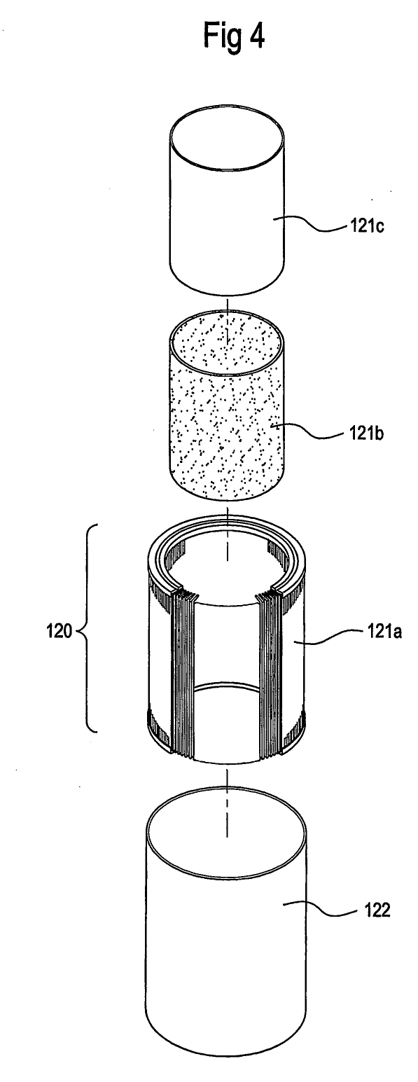

In addition, the wrinkle filter 121a is formed in a cylindrical shape and has a certain wrinkle width and is winkled in a zigzag shape for thereby enhancing a filtering effect by increasing the touch area with the air. As shown in FIG. 4, since the carbon filter 121b having an active carbon and the nano silver filter 121c having silver particles are installed in the double structure, so that a harmful gas, bacteria and smell contained in the air are cleaned.

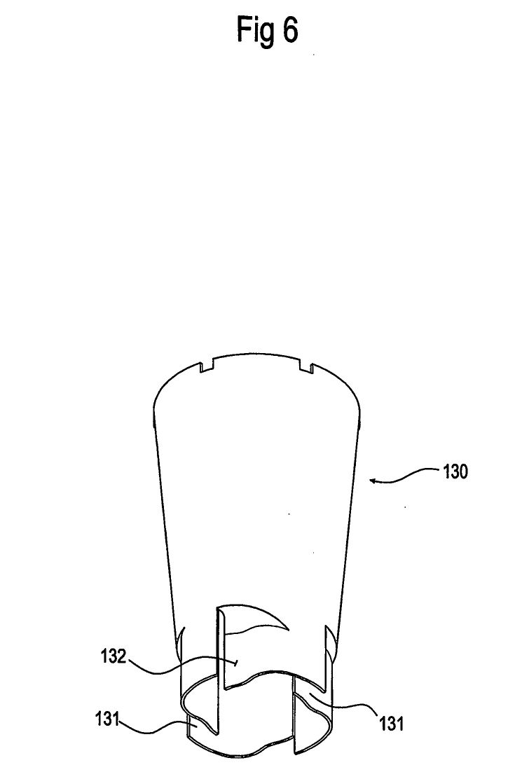

In particular, as shown in FIG. 6, in the air inlet guide 130 of the present invention, the upper side is wide, and the lower side is narrow. In addition, there is provided a turbulence generating wing part 132 in the air inlet part 131, so that the air inputted through the air inlet part 131 is discharged in the upward direction in a turbulence state. Therefore, in the present invention, an air cleaning function is enhanced based on a gas cyclon effect (that is achieved based on a certain apparatus or a function by which floating solid particles of a few μm or a few hundreds μm are separated using a turbulence gas centrifugal force).

After the filtering operation is performed, the air discharged is discharged through the rotation discharge guide part 151 of the top housing 150. Here, since small wing parts 151a of the rotation discharge guide part are inclined at a certain angle, the air is discharged in the upward direction in a radial shape.

Since the dust density detection sensor 170 is provided in the interior of the sensor cover part 145 of the present invention, when the indoor air is polluted above a default value of the sensor, the system is automatically operated.

In addition, since the temperature detection sensor 190 is provided in the interior of the fan housing 144, when the temperature of the indoor air is low, the electric heater 160 is operated for thereby heating and discharging the air cleaned. Using the gas density detection sensor 180, the presence state and density of the gas are checked. If needed, the ultraviolet ray sterilizer 220 is operated automatically.

The ion generator 210 is provided in the interior of the top housing 150, so that the anion can be included in the cleaned and discharged air by operating the operation knob.

### INDUSTRIAL APPLICABILITY

As described above, in the present invention, the entire structure of the air cleaner according to the present invention is formed in a cylindrical shape. In addition, it is designed in such a manner that the air is sucked through the entire surface of a cylindrical body and the cleaned air is discharged in the upward direction. Therefore, the air of larger spaces is fast cleaned, and the inlet air and the outlet air are not mixed each other for thereby achieving an effective cleaning operation.

In addition, in the present invention, there are provided a gas removing function and a sterilization function as well as a filtering function for cleaning air, so that it is possible to achieve a good quality air. There is provided an air heating function implemented using the electric heater, so that it is possible to provide a heated air without additionally using a heating apparatus for going up the temperature of the indoor air. There is a function for setting a cleaning time period for thereby achieving an automatic operation. All operations are performed using a wireless remote controller, so that the use of the system is very convenient.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. An air cleaner, comprising:
a cylindrical body fixed to a bottom circular disc wherein an entire appearance of the same is formed of a grill part;
a filter unit including a non-woven fabric filter provided in an inner side of the grill part of the cylindrical body, and a cylindrical filer cartridge having a cylindrical wrinkle filter in an inner side;
an air inlet guide installed in the interior of the filter unit and having an air inlet part in a lower side wherein an upper side of the same is wide, and a lower side of the same is narrow like a reverse conical shape;
an air supply unit assembly including a support circular disc having an air hole and a protrusion part at a center for covering the upper sides of the cylindrical body, the filter unit and the air inlet guide, a motor fixed to the protrusion part of the support circular disc, a fan fixed to a rotary axis of the motor, and a fan housing having an air discharge hole formed along a rim of an upper side surface, while surrounding the fan;
a top housing assembled to an upper side surface of the air supply unit assembly and having a controller with an operation knob in an upper side surface, and a handle wherein a rotation discharge guide part corresponding to the air discharge hole is formed along the rim; and
an electronic circuit substrate provided between an upper side of the air supply unit assembly and a lower surface of the top housing.

2. The cleaner of claim 1, wherein said air supply unit assembly includes a plurality of electric heaters in an inner side of the air discharge hole.

3. The cleaner of claim 1, wherein said air supply unit assembly includes a sensor cover part extended in a lower direction of one side wherein a dust density detection sensor is provided in the interior of the sensor cover part.

4. The cleaner of claim 1, wherein in said air supply unit assembly, a sensor hole is formed in one side of the fan housing, and a gas density detection sensor and a temperature detection sensor are provided in the inner side of the fan housing.

5. The cleaner of claim 1, wherein said air supply unit assembly includes an air guide member capable of guiding the air flowing from the air hole to the air discharge hole in the upper direction, not the bottom.

6. The cleaner of claim 1, wherein said air supply unit assembly includes a ultraviolet ray sterilizer having a pair of ultraviolet ray lamps on the bottom of the support circular disc.

7. The cleaner of claim 1, wherein said air inlet part of the air inlet guide comprises a radial wing part for guiding the flow of air to turbulence flow.

8. The cleaner of claim 1, wherein said filter cartridge of the filter unit comprises a wrinkle filter, and a carbon filter being adherent to the inner surface of the wrinkle filter.

9. The cleaner of claim 1, wherein said filter cartridge of the filter unit includes a wrinkle filter, a carbon filter being adherent to the inner surface of the wrinkle filter, and a nano silver filter being adherent to the inner surface of the carbon filter.

10. The cleaner of claim 1, wherein said top housing includes an ion generator therein, wherein a discharge hose connected to the ion generator is exposed from one side of the controller to the outside.
